(19) United States
(12) Patent Application Publication
(10) Pub. No.: US 2026/0111334 A1
(43) Pub. Date: Apr. 23, 2026

(54) TRAINING DATA EFFECTIVENESS EVALUATION METHOD, SYSTEM, AND DEVICE

(71) Applicant: ZHEJIANG LAB, Hangzhou (CN)

(72) Inventors: Yao QI, Hangzhou (CN); Longfei LIAO, Hangzhou (CN); Lvwen FU, Hangzhou (CN); Sheng ZHANG, Hangzhou (CN); Guirong XUE, Hangzhou (CN); Hongyang CHEN, Hangzhou (CN); Jiang YANG, Hangzhou (CN); Ziqi SONG, Hangzhou (CN)

(73) Assignee: ZHEJIANG LAB, Hangzhou (CN)

(21) Appl. No.: 19/385,199

(22) Filed: Nov. 11, 2025

Related U.S. Application Data
(63) Continuation of application No. PCT/CN2025/080183, filed on Mar. 3, 2025.

(30) Foreign Application Priority Data
Oct. 23, 2024 (CN) 202411481596.1

(51) Int. Cl. G06F 11/34; G06F 11/30; G06N 20/00

(52) U.S. Cl. CPC G06F 11/3447; G06F 11/3017; G06N 20/00

(57) ABSTRACT

A training data effectiveness evaluation method includes: acquiring a training set, where the training set is acquired by uniform downsampling from target data; acquiring a test set, where the test set includes at least one benchmark test set and at least one correlated test set; training a probe model based on the training set; testing the probe model based on the test set, and recording test metrics; generating an observation plot based on the test metrics, where the generating the observation plot includes: establishing a Cartesian coordinate system with a test metric of the benchmark test set as a horizontal axis and a test metric of the correlated test set as a vertical axis, and plotting key points in the Cartesian coordinate system based on the test metrics; and evaluating effectiveness of the target data based on the observation plot. The present disclosure has the following advantages.

### CROSS REFERENCE TO THE RELATED APPLICATIONS

This application is the continuation application of International Application No. PCT/CN2025/080183, filed on Mar. 3, 2025, which is based upon and claims priority to Chinese Patent Application No. 202411481596.1, filed on Oct. 23, 2024, the entire contents of which are incorporated herein by reference.

### TECHNICAL FIELD

The present disclosure relates to the field of artificial intelligence (AI), and in particular to a training data effectiveness evaluation method, system, and device.

### BACKGROUND

With the advancement of internet technology, AI has become an important part of people's daily lives. As AI businesses emerge, user requirements for the accuracy of AI models are continuously increasing. The ever-increasing accuracy requirements drive rapid growth in both model scale and training data volume.

Currently, training a high-quality AI model faces the challenge that due to the large model scale and training data volume, the computational power and time cost consumed per single experiment are very high.

### SUMMARY

To address the shortcomings of the prior art, the present disclosure provides a training data effectiveness evaluation method, system, and device. The present disclosure directly evaluates training data effectiveness using a small-scale probe model, offering significant advantages such as low computational power consumption, low time cost, accurate evaluation results, and strong robustness.

According to a first aspect, the present disclosure provides a training data effectiveness evaluation method, including:
acquiring a training set, where the training set is acquired by uniform downsampling from target data;
acquiring a test set, where the test set includes at least one benchmark test set and at least one correlated test set;
training a probe model based on the training set;
testing the probe model based on the test set, and recording test metrics;
generating an observation plot based on the test metrics, where the generating the observation plot includes: establishing a Cartesian coordinate system with a test metric of the benchmark test set as a horizontal axis and a test metric of the correlated test set as a vertical axis; and plotting key points in the Cartesian coordinate system based on the test metrics; and evaluating effectiveness of the target data based on the observation plot.

Furthermore, the training the probe model includes: updating a weight of the probe model by backpropagation and gradient descent.

Furthermore, the updating the weight of the probe model by backpropagation and gradient descent includes: converting a training corpus into a token, feeding the token into the probe model for forward propagation, and generating an output token; calculating a cross-entropy loss of the output token, and calculating a gradient of the probe model by backpropagation; and updating the weight of the probe model by a gradient descent algorithm.

Furthermore, the probe model is tested by test data and a metric calculation method, and the recording the test metrics includes: recording the test metrics of the probe model on the test set for at least two convergence stages.

Furthermore, the plotting key points in the Cartesian coordinate system based on the test metrics includes: reading the test metrics corresponding to the horizontal axis and the vertical axis of an optimization stage to form coordinates, and plotting a key point; and traversing all convergence stages to plot other key points.

Furthermore, the method includes: evaluating effectiveness of the training data based on the observation plot, including: fitting a curve to the key points; determining that, if the test metric of the correlated test set is better when smaller, a lower position of the curve indicates better training data effectiveness; and determining that, if the test metric of the correlated test set is better when larger, a higher position of the curve indicates better training data effectiveness.

In a second aspect, the present disclosure further provides a training data effectiveness evaluation system, including: an acquisition module, a training module, a testing module, and an evaluation module, where
the acquisition module is configured to acquire a training set and a test set, where the training set is acquired by uniform downsampling from target data, and the test set includes at least one benchmark test set and at least one correlated test set;
the training module is configured to train a probe model based on the training set;
the testing module is configured to test the probe model based on the test set, record test metrics, and generate an observation plot based on the test metrics; and
the evaluation module is configured to evaluate effectiveness of the target data based on the observation plot.

According to a third aspect, the present disclosure further provides a training data effectiveness evaluation device, including: a memory and at least one processor, where the memory is configured to store an executable code; and when the processor executes the executable code, the training data effectiveness evaluation method is implemented.

According to a fourth aspect, the present disclosure further provides a computer-readable storage medium, configured to store a program, where when the program is executed by a processor, the training data effectiveness evaluation method is implemented.

According to a fifth aspect, the present disclosure further provides a computer program product, including a computer program, where when the computer program is executed by a processor, the training data effectiveness evaluation method is implemented.

The present disclosure has the following advantages. The present disclosure enables rapid data effectiveness evaluation with very low computational power consumption, greatly improving model development and iteration efficiency, and significantly improving gains, especially for cutting-edge complex models.

### BRIEF DESCRIPTION OF THE DRAWINGS

In order to describe the technical solutions in the embodiments of the present disclosure more clearly, the drawings required to describe the embodiments are briefly described below. Apparently, the drawings described below are only some embodiments of the present disclosure. Those of ordinary skill in the art may further obtain other drawings based on these drawings without creative efforts.

FIG. 1 is a flowchart of a training data effectiveness evaluation method in Embodiment 1 of the present disclosure;

FIG. 2 is a flowchart of probe model training in Embodiment 6 of the present disclosure;

FIG. 3 is a flowchart of plotting key points in a Cartesian coordinate system in Embodiment 8 of the present disclosure;

FIG. 4 is an example of an observation plot in Embodiment 8 of the present disclosure;

FIG. 5 is an example of an observation plot in Embodiment 9 of the present disclosure;

FIG. 6 is a flowchart of evaluating effectiveness of target data in Embodiment 9 of the present disclosure; and

FIG. 7 is a structural diagram of a training data effectiveness evaluation device provided by the present disclosure.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by a person of ordinary skill in the art based on the examples of the present disclosure without creative efforts shall fall within the protection scope of the present disclosure.

It should be noted that, if there is no conflict, the following embodiments and features in implementations may be mutually combined.

### Embodiment 1

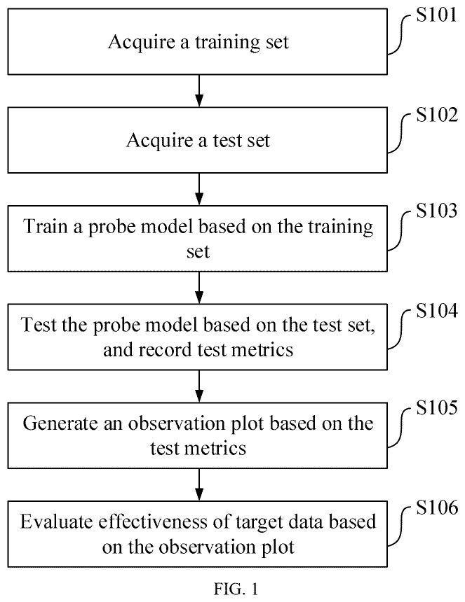

The embodiment of the present disclosure provides a training data effectiveness evaluation method. FIG. 1 is a flowchart of the training data effectiveness evaluation method in the embodiment of the present disclosure. The method includes following steps.

S101. A training set is acquired, where the training set is acquired by uniform downsampling from target data.

S102. A test set is acquired, where the test set includes at least one benchmark test set and at least one correlated test set.

S103. A probe model is trained based on the training set.

S104. The probe model is tested based on the test set, and test metrics are recorded.

S105. Based on the test metrics, an observation plot is generated by establishing a Cartesian coordinate system with a test metric of the benchmark test set as a horizontal axis and a test metric of the correlated test set as a vertical axis; and plotting key points in the Cartesian coordinate system based on the test metrics.

S106. Based on the observation plot, effectiveness of the target data is evaluated.

In the above steps, the format of the training set is not limited, as long as it meets business requirements. To train a large language model, the training set can be text such as natural language, mathematical symbols, or code. To train a vision model, the training data can be images, image classification labels, image object detection labels, image segmentation labels, etc. To train a multimodal question-answering model, the training set can be images or videos paired with corresponding question-answer text. This means the method of the present disclosure can adapt to diverse target data and model algorithm types. The training set is acquired by uniform downsampling from target data, preserving the data distribution of the target data while reducing the number of samples in the training set, thereby improving efficiency of the method.

The test set is primarily acquired based on downstream task requirements. Similar to the training set, to train a large language model, the test set can be common-sense test questions, math problems, coding problems, etc. The common-sense test questions and math problems can use accuracy as the evaluation metric, the coding problems can use successful execution rate as the evaluation metric. To train a vision model, the test set is acquired based on the required downstream task type, such as image classification test sets, object detection test sets, and image segmentation test sets. To train an image-text multimodal model, the test set can be the aforementioned text-related tasks, the aforementioned image-related tasks, or combined image-text tasks like question-answering comprehension, image generation, video understanding, video generation, etc. For models required by other businesses, the test set is acquired based on business type and downstream task requirements.

In the above steps, the training set is a small portion uniformly sampled from the complete training data, and the probe model is a very small-scale model. Therefore, the training can be completed with very low computational power in a short time, ensuring method efficiency. The observation plot combines test metrics from multiple test sets, simultaneously reflecting the training set data's response to multiple downstream tasks, ensuring reliability of the method.

After the business type and downstream tasks are determined, the test set can be flexibly established using 4 optional approaches. For a complex multi-task model, there are usually some basic downstream tasks that can serve as benchmark test sets, while other more specialized downstream tasks can serve as correlated test sets.

### Embodiment 2

In a preferred embodiment, the business requirement is a general large language model. For a large language model, its benchmark capability can be defined as natural language fluency, thus web text data can be acquired as the test set, with text perplexity (PPL) as the metric calculation method. The correlated test sets can include massive multitask language understanding (MMLU) (knowledge-based test questions, accuracy metric), HumanEval (coding test set, code execution metric, example pass rate, etc.), gsm8k (mathematical ability, accuracy metric), etc.

### Embodiment 3

In another preferred embodiment, the business requirement is a general large language model, and its benchmark capability can be defined as Chinese fluency and English fluency. Thus, the following two benchmark test sets can be acquired: 1) Chinese web data, using text PPL as the metric calculation method; and 2) English web data, using text PPL as the metric calculation method. The establishment of correlated test sets can be the same as that in Embodiment 2, or some downstream tasks can be added or removed.

### Embodiment 4

In another preferred embodiment, the business requirement is a vision model, and its benchmark capability can be defined as image classification ability, thus abundant images and image category information can be acquired as the test set, using accuracy as the metric calculation method. The correlated test sets can be object detection test sets, using mean average precision (mAP) as the metric calculation method, or segmentation test sets, using pixel accuracy as the metric calculation method.

### Embodiment 5

In another preferred embodiment, the business requirement is a multimodal question-answering model, and its benchmark capability can be defined as natural language fluency and image classification ability (using generated text for category prediction). Thus, the following two benchmark test sets are acquired: 1) web data, using text PPL as the metric calculation method; and 2) images and text-represented image categories, using accuracy, text edit distance, etc. as metrics. Corresponding correlated test sets can be image-text question-answering, using key point recall rate as the metric calculation method, or text-to-image generation, using contrastive language-image pre-training (CLIP) score as the metric calculation method.

After the training set and the test set are determined, some metrics are observed by the probe model. The training of the probe model is actually determined by the model structure and algorithm. Currently, the optimization algorithms for the most complex models are primarily gradient-based.

### Embodiment 6

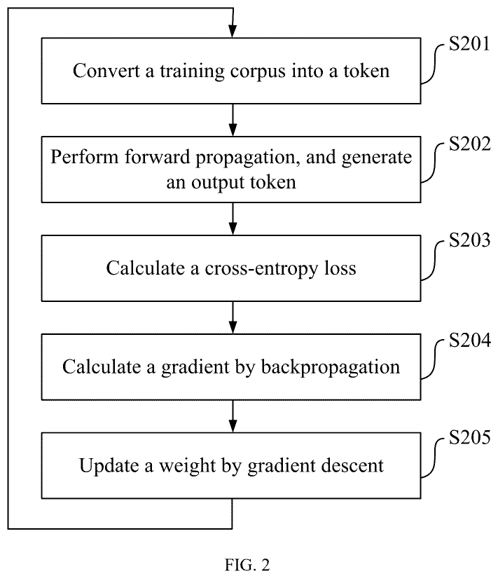

In a preferred embodiment, in the step S103 above, the probe model is trained as follows. Specifically, backpropagation and gradient descent algorithm are applied to update the model weight multiple times until convergence, as shown in FIG. 2. Taking the optimization of the large language model in Embodiment 2 as an example, first, the training corpus is converted into a token, and the token is fed into the probe model for forward propagation to obtain an output token. Then, the cross-entropy loss of the output token is calculated, and the gradient of the probe model is calculated by backpropagation. The weight of the probe model is updated by a gradient descent algorithm. This process is repeated until all training set data is processed.

If the probe model uses other algorithms like clustering, the corresponding optimization strategy is applied, and this will not affect the implementation of the method. After the probe model optimization strategy is determined, it is necessary to evaluate the probe model at different optimization levels.

### Embodiment 7

Taking Embodiment 6 as an example, in yet another preferred embodiment, in the step S104 above, the probe model is tested by test data and metric calculation method as follows. The test metrics of the probe model on the test set for at least two convergence stages are recorded. Specifically, each time 1/10 of the training set is consumed, the probe model is considered to reach a new optimization stage. Then, the probe model at this new optimization stage is tested on the test set to obtain 10 sets of test metrics.

The definition of the optimization stage is diverse. Besides the definition in Embodiment 7, a new optimization stage is considered each time when the training lasts certain duration. Alternatively, a new optimization stage is considered each time when the weight of the probe model is updated a certain number of times. Depending on the specific implementation of the optimization stage, more or less than 10 sets of test metrics can be acquired, and this does not affect the implementation of the method.

### Embodiment 8

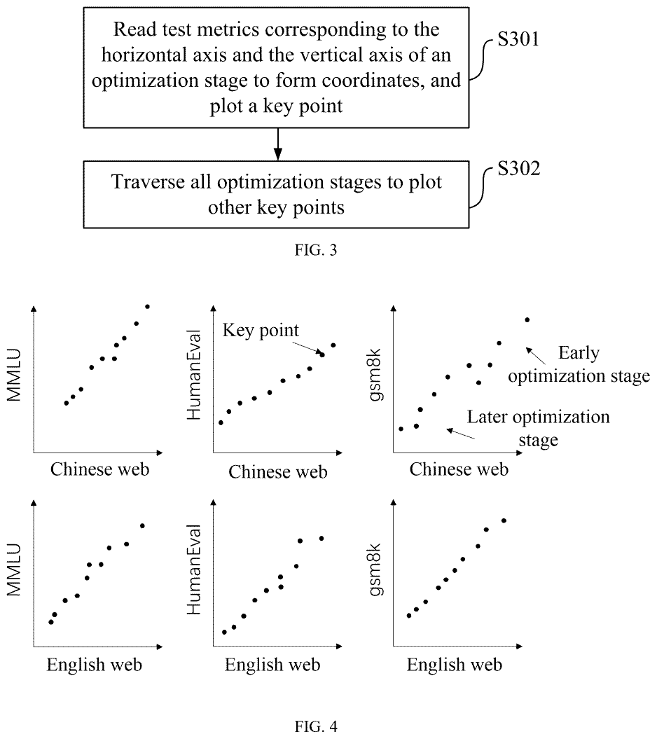

In a preferred embodiment, it is assumed the configuration of the benchmark test set is as described in Embodiment 3, the configuration of the correlated test set is as described in Embodiment 2, and the training and testing of the probe model are as described in Embodiment 7. Thus, the experimental configuration includes 2 benchmark test sets and 3 correlated test sets. Pairwise combinations of the benchmark tests and the correlated test sets result in 6 configurations. In the step S105 above, a Cartesian coordinate system is established with the test metric of the benchmark test set as a horizontal axis and the test metric of the correlated test set as a vertical axis, yielding 6 different Cartesian coordinate systems. As shown in FIG. 3, in the step S105 above, the key points in the Cartesian coordinate systems are plotted based on the test metrics.

S301. Test metrics corresponding to the horizontal axis and the vertical axis of an optimization stage are read to form coordinates, and a key point is plotted.

S302. All optimization stages are traversed, and other key points are plotted.

Specifically, the first set of test metrics are read from Embodiment 7 and one key point is plotted in each of the 6 coordinate systems. Then the other 9 sets of test metrics are traversed, and key points are plotted in the 6 coordinate systems. Ultimately, each coordinate system includes 10 key points, forming an observation plot, as shown in FIG. 4.

### Embodiment 9

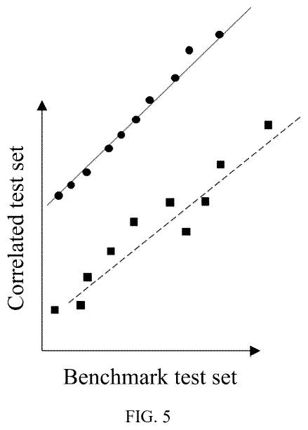

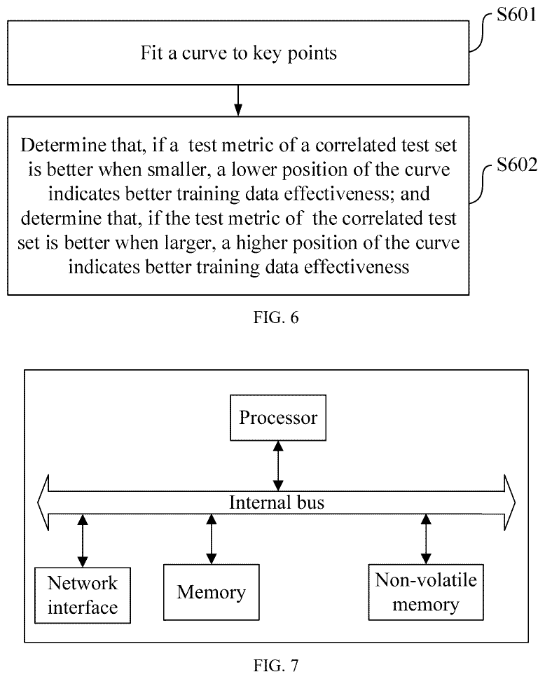

In a preferred embodiment, the configuration of the test set is fixed, including one benchmark test set (web text) and one correlated test set (humaneval). It is assumed there are two target data and the observation plots described in the step S105 above are drawn, as shown in FIG. 5. Circle points are plotted for target data 1, and square points for target data 2. As shown in FIG. 6, in the step S106 above, the effectiveness of the target data is evaluated based on the observation plot.

S601. A curve is fit to the key points.

S602. If the test metric of the correlated test set is better when smaller, it is determined that a lower position of the curve indicates better training data effectiveness. If the test metric of the correlated test set is better when larger, it is determined that a higher position of the curve indicates better training data effectiveness.

Specifically, the circle points corresponding to the target data 1 are fitted to line 1 (solid line in FIG. 5), and the square points corresponding to the target data 2 are fitted to line 2 (dashed line in FIG. 5). The dashed line is below the solid line, allowing the following decision: when the test metric of the correlated test set is better when smaller, the effectiveness of the data 2 is higher than the data 1. When the test metric of the correlated test set is better when larger, the effectiveness of the data 1 is higher than the data 2.

Embodiment 9 uses only one benchmark test set and one correlated test set as an example. When the configuration of the test set is richer, like that in Embodiment 8, the observation plot will include multiple subplots. Across various tasks, the target data 1 and the target data 2 may each have strengths and weaknesses, and trade-offs can be made using win ratio or task importance ranking.

Corresponding to the above embodiment of the training data effectiveness evaluation method, an embodiment of the present disclosure further provides a training data effectiveness evaluation system. The system includes an acquisition module, a training module, a testing module, and an evaluation module. For specific implementation processes of each of the modules, please refer to the specific steps of the embodiment of the training data effectiveness evaluation method.
the acquisition module is configured to acquire a training set and a test set, where the training set is acquired by uniform downsampling from target data, and the test set includes at least one benchmark test set and at least one correlated test set;
the training module is configured to train a probe model based on the training set;
the testing module is configured to test the probe model based on the test set, record test metrics, and generate an observation plot based on the test metrics; and
the evaluation module is configured to evaluate effectiveness of the target data based on the observation plot.

Corresponding to the above embodiment of the training data effectiveness evaluation method, an embodiment of the present disclosure further provides a training data effectiveness evaluation device.

Referring to FIG. 7, an embodiment of the present disclosure provides a training data effectiveness evaluation device, including: a memory and at least one processor. The memory is configured to store an executable code; and when the processor executes the executable code, the training data effectiveness evaluation method in the above embodiment is implemented.

The embodiment of the training data effectiveness evaluation device provided by the present disclosure can be applied to any device with a data processing capability, such as a computer or other devices or apparatuses. The apparatus embodiment can be implemented through software, hardware, or a combination of software and hardware. Using software implementation as an example, as a logical apparatus, it is formed by reading, by a processor of a device with a data processing capability where the apparatus is located, corresponding computer program instructions from a non-volatile memory into a memory for running. From a hardware perspective, FIG. 7 is a hardware structure diagram of a device with a data processing capability where the training data effectiveness evaluation device provided by the present disclosure is located. In addition to the processor, memory, network interface, and non-volatile memory shown in FIG. 7, the device with a data processing capability, where the device of the embodiment is located, may typically include other hardware based on the actual functionality of the device with a data processing capability, and details are not described herein.

The specific implementation process of the functions and roles of each unit in the above apparatus is detailed in the corresponding steps of the foregoing method and is not described herein again.

For the apparatus embodiment, since it substantially corresponds to the method embodiment, it is sufficient to refer to a part of the description of the method embodiment where relevant. The device embodiment described above is merely schematic, where the unit described as a separate component may or may not be physically separated, and a component displayed as a unit may or may not be a physical unit, that is, the component may be located at one place, or distributed on multiple network units. Some or all of its modules may be selected according to actual needs to implement the solutions of the present disclosure. Those of ordinary skill in the art can understand and implement the embodiments without creative effort.

An embodiment of the present disclosure further provides a computer-readable storage medium, configured to store a program. When the program is executed by a processor, the training data effectiveness evaluation method in the above embodiment is implemented.

The computer-readable storage medium may be an internal storage unit of the device with a data processing capability described in any of the above embodiments, such as a hard disk or a memory. The computer-readable storage medium may alternatively be an external storage device of the device with a data processing capability, such as a plug-in hard disk, a smart media card (SMC), a secure digital (SD) card, or a flash card equipped on the device. Further, the computer-readable storage medium may alternatively include both an internal storage unit and an external storage device of the device with a data processing capability. The computer-readable storage medium is configured to store the computer program and other programs and data that are required by the device with a data processing capability, or may further be configured to temporarily store data that has been output or to be output.

The present disclosure further provides a computer program product including a computer program. When the computer program is executed by a processor, the training data effectiveness evaluation method is implemented.

The embodiments in the present disclosure are described in a progressive manner. For same or similar parts between embodiments, reference may be made to each other. Each embodiment focuses on a difference from other embodiments. For a system embodiment, since it is basically similar to the method embodiment, the description is relatively simple, and reference can be made to the description of the method embodiment.

The above descriptions are merely embodiments of the present disclosure, which are not intended to limit the present disclosure. Various changes and modifications may be made to the present disclosure by those skilled in the art. Any modification, equivalent substitution and improvement made within the spirit and principle of the present disclosure should fall within the protection scope of the claims of the present disclosure.

1. A training data effectiveness evaluation method, comprising:
acquiring a training set, wherein the training set is acquired by uniform downsampling from target data;
acquiring a test set, wherein the test set comprises a benchmark test set and a correlated test set;
training a probe model based on the training set;
testing the probe model based on the test set, and recording test metrics;
generating an observation plot based on the test metrics, wherein the generating the observation plot comprises: establishing a Cartesian coordinate system with a test metric of the benchmark test set as a horizontal axis and a test metric of the correlated test set as a vertical axis; and plotting key points in the Cartesian coordinate system based on the test metrics as follows: reading the test metrics corresponding to the horizontal axis and the vertical axis of an optimization stage to form coordinates, and plotting a key point; and traversing all optimization stages to plot other key points; and
evaluating effectiveness of the target data based on the observation plot, comprising: fitting a curve to the key points, and evaluating by comparing positions of the curve corresponding to different target data; determining that, if the test metric of the correlated test set is better when smaller, a lower position of the curve indicates better training data effectiveness; and determining that, if the test metric of the correlated test set is better when larger, a higher position of the curve indicates better training data effectiveness.

2. The training data effectiveness evaluation method according to claim 1, wherein the training the probe model comprises: updating a weight of the probe model by backpropagation and gradient descent.

3. The training data effectiveness evaluation method according to claim 2, wherein the updating the weight of the probe model by backpropagation and gradient descent comprises:
converting a training corpus into a token, feeding the token into the probe model for forward propagation, and generating an output token; calculating a cross-entropy loss of the output token, and calculating a gradient of the probe model by backpropagation; and updating the weight of the probe model by a gradient descent algorithm.

4. The training data effectiveness evaluation method according to claim 1, wherein the probe model is tested by test data and a metric calculation method, and the recording the test metrics comprises: recording the test metrics of the probe model on the test set for at least two convergence stages.

5. A training data effectiveness evaluation system, for implementing the training data effectiveness evaluation method according to claim 1, and comprising: an acquisition module, a training module, a testing module, and an evaluation module, wherein
the acquisition module is configured to acquire a training set and a test set, wherein the training set is acquired by uniform downsampling from target data, and the test set comprises a benchmark test set and a correlated test set;
the training module is configured to train a probe model based on the training set;
the testing module is configured to test the probe model based on the test set, record test metrics, and generate an observation plot based on the test metrics; and
the evaluation module is configured to evaluate effectiveness of the target data based on the observation plot.

6. A training data effectiveness evaluation device, comprising: a memory and at least one processor, wherein the memory is configured to store an executable code; and when the processor executes the executable code, the training data effectiveness evaluation method according to claim 1 is implemented.

7. A computer-readable storage medium, configured to store a program, wherein when the program is executed by a processor, the training data effectiveness evaluation method according to claim 1 is implemented.

8. A computer program product, comprising: a computer program, wherein when the computer program is executed by a processor, the training data effectiveness evaluation method according to claim 1 is implemented.
